(19) United States
(12) Patent Application Publication
(10) Pub. No.: US 2002/0083554 A1
(43) Pub. Date: Jul. 4, 2002

(54) Concealed retaining device for a pivot

(76) Inventor: Sheng-Nan Lu, Taipei Hsien (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/753,970

(22) Filed: Jan. 3, 2001

(51) Int. Cl. E05D 11/08; E05C 17/64

(52) U.S. Cl. 16/340

(57) ABSTRACT

A retaining device concealed in a pivot of an LCD screen has an L-shaped fixed seat having a first end portion secured on a base and a second end portion defined therein with a retaining hole shaped substantially as a figure eight, a pivotal axle having a connecting end portion pivotally connected with the fixed seat and a fixing end portion securely mounted with a screen, and multiple oiled washers provided at the second end portion of the fixed seat. Whereby the connecting end portion of the pivotal axle is extended through at least one of the multiple washers, the retaining hole of the fixed seat and at least one of the multiple washers and an elastic ring, and fastened at a free end thereof. In such a way the pivotal axle is able to smoothly pivot within the retaining hole of the fixed seat.

### BACKGROUND OF THE INVENTION

1. Field of the Invention

The present invention relates to a concealed retaining device used in a pivot of an LCD screen, particularly to the retaining device having a good resistance to wear so as to prolong its working life.

2. Description of Related Art

A conventional pivot of an LCD screen as shown in FIG. 11 normally comprises a base (90), a fixed seat (91) secured on a center of the base (90), a connecting rod (92) having a lower end thereof connected with the fixed seat (91) and rotatable about its central axis, a connecting portion (93) secured on an upper end of the connection rod (92), and a bracket (95) securely mounted with an LCD screen (not shown in the drawing) and pivotally connected with the connected portion (93). Wherein a retaining device of the pivot consists of two arc shaped guide ways (94) symmetrically defined at opposite sides of the connecting portion (93), and two slide blocks (96) integrally formed at opposite sides of the bracket (95) corresponding to the guide ways (94). Whereby the sliding blocks (96) are respectively movable along the guide ways (94) and limited within the guide ways (94), when the bracket (95) is pivotally connected with the connecting portion (93).

The disadvantage of the conventional retaining device for the pivot of the LCD screen is that the sliding blocks (96) and the guide ways (94) are exposed to the open air, so the slide fitting between the sliding blocks (96) and the guide ways (94) can not be lubricated. After having been used for a period of time, the guide ways (94) and the sliding blocks (96) will be covered with dust, which causes the LCD screen to lose its smoothness of the pivotal movement, and the working life of the retaining device is reduced.

Therefore, it is an objective of the invention to provide a concealed retaining device for a pivot of an LCD to mitigate and/or obviate the aforementioned problems.

### SUMMARY OF THE INVENTION

The object of the invention is to provide an improved retaining device, which is concealed in a pivot and easily able to be lubricated, so as to increase its durability and prolong the use life of the retaining device.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a retaining device for a pivot in accordance with the invention;

FIG. 2 is an exploded perspective view of a second embodiment of a retaining device for a pivot in accordance with the invention;

FIG. 3 is an exploded perspective view of a third embodiment of the retaining device for the pivot in accordance with the invention;

FIG. 4 is an exploded perspective view of a fourth embodiment of the retaining device for the pivot in accordance with the invention;

FIG. 5 is an exploded perspective view of a fifth embodiment of the retaining device for the pivot in accordance with the invention;

FIG. 6 is an exploded perspective view of a sixth embodiment of the retaining device for the pivot in accordance with the invention;

FIG. 7 is a cross sectional schematic view of operation of the retaining device of the invention, showing a pivotal axle turning in an anti-clockwise direction being retained by the retaining device;

FIG. 8 is a cross sectional schematic view of operation of the retaining device of the invention, showing the pivotal axle turning in a clockwise direction being retained by the retaining device;

FIG. 9 is perspective view of a first assembly embodiment of the retaining device in accordance with the invention;

FIG. 10 is perspective view of a second assembly embodiment of the retaining device in accordance with the invention; and

FIG. 11 is an exploded perspective view of a conventional retaining device of a pivot.

### DETAILED DESCRIPTION OF THE PREFERRED EMBODIMENT

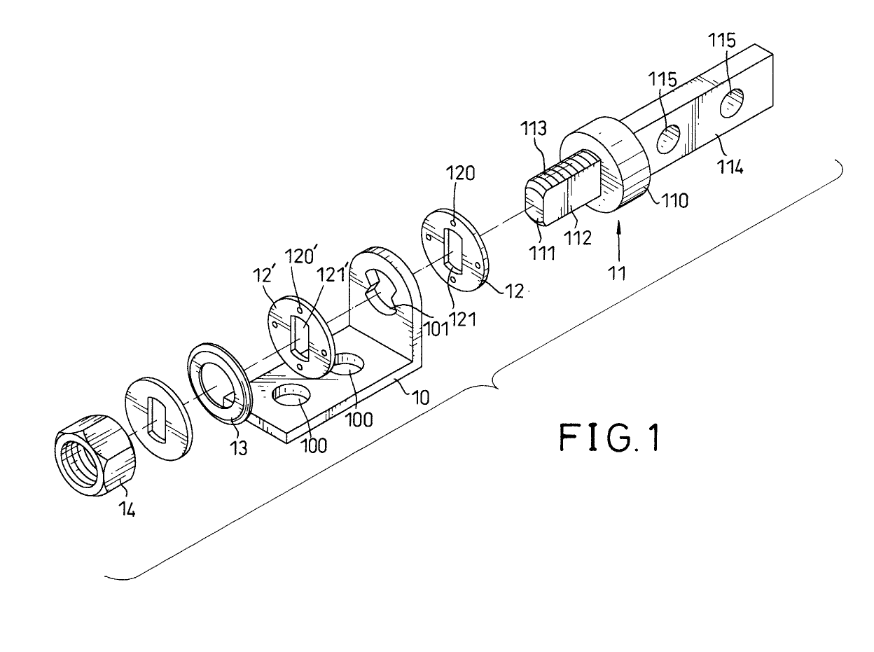

As shown in FIGS. 1 to 6, the present invention relates to a concealed retaining device of a pivot for an LCD screen, the retaining device particularly comprises an L-shaped fixed seat (10) and a pivotal axle (11) pivotally connected with the fixed seat (10). The fixed seat (10) has a first end portion securely mounted on a base (not shown in the drawings) and a second end portion which is substantially perpendicular to the first end portion and therein defined with a retaining hole (101) shaped substantially as a figure of eight. The pivotal axle (11) has a retaining shoulder (110) formed at a middle portion thereof, a connecting end portion (111) integrally formed at a first end of the retaining shoulder (110), and a fixing end portion (114) integrally formed at a second end of the retaining shoulder (110). The connecting end portion (111) of the pivotal axle (11) is extended through the retaining hole (101) of the fixed seat (10), and is pivotally movable within the retaining hole (101) of the fixed seat (10). The fixing end portion (114) of the pivotal axle (11) is fixedly connected with an LCD screen (not shown in drawings).

The first end portion of the fixed seat (10) is defined with at least two fixing holes (100). The connecting end portion (111) of the pivotal axle (11) is formed with a thread (113) therearound and formed with two parallel flat surfaces (112) at opposite sides thereof. The fixing end portion (114) of the pivotal axle (11) is defined with at least two positioning holes (115). The connecting end portion (111) of the pivotal axle (11) is extended through at least one of multiple first washers (12), the retaining hole (101) of the fixed seat (10), and at least one of the multiple second washers (12′), and then fastened by means of riveting or fastening with a fastening piece, such as a screw nut, whereby the pivotal axle (11) is pivotally connected with the fixed seat (10) and is movable within a limitation scope of the retaining hole (101).

As shown in FIG. 1, in a first embodiment of the retaining device, one of the multiple first washers (12) is provided between a first side of the second end portion of the fixed seat (10) and the retaining should (110) of the pivotal axle (11), one of the multiple second washers (12′) is provided between a second side of second end portion of the fixed seat (10) and an elastic ring (13). The first and second of the washers (12, 12′) are respectively defined with two though holes (121, 121′) corresponding to the cross-sectional shape of the connecting end portion (111), and are further respectively defined with a plurality of oil-holes (120, 120′) therearound. The connecting end portion (111) is extended through the through hole (121) of the first washer (12), the retaining hole (101) of the fixed seat (10), the through hole (121′) of the second washer (12′) and the elastic ring (13), and then fastened with a screw nut (14) at a free end thereof.

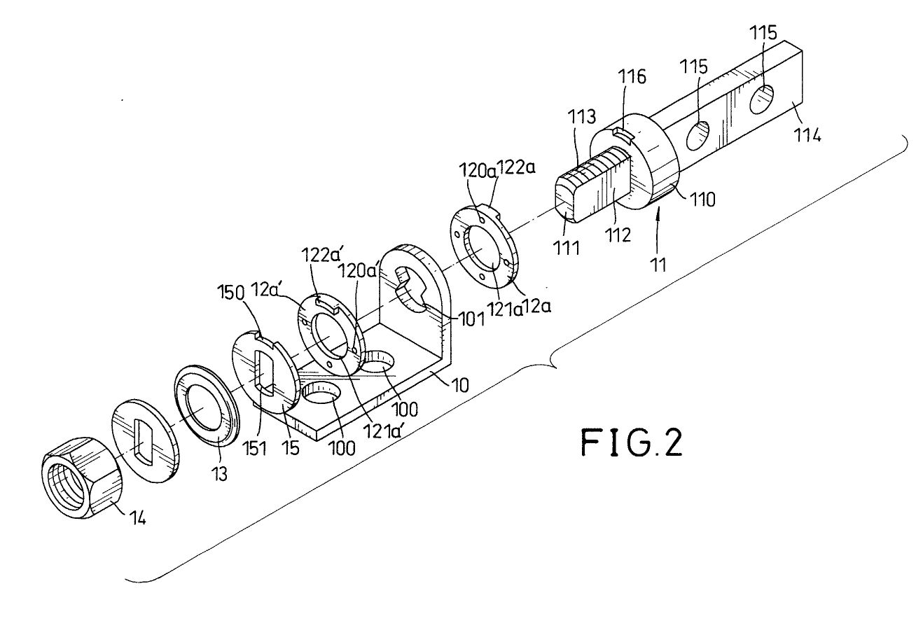

In a second embodiment of the retaining device as shown in FIG. 2, a first and a second washers (12a, 12a′) respectively have their through holes (121a, 121a′) defined in circular shape, and each is integrally formed with a projected block (122a, 122a′) on one side surface thereof. The retaining shoulder (110) is further defined with a recess (116) corresponding to the projected block (122a) of the first washer (12a) adjacent the retaining shoulder (110). A secondary washer (15) is provided between the elastic ring (13) and the second washer (12a′) abutted against the second side of the second end portion of the fixed seat (10). The secondary washer (15) is defined with a slot (150) corresponding to the projected block (122a′) of the second washer (12a′) abutted against the secondary washer (15), and is further defined with a fitting hole (151) in a center thereof corresponding to the cross-sectional shape of the connecting end portion (111). The connecting end portion (111) is extended through the through hole (121a) of the first washer (12a), the retaining hole (101) of the fixed seat (10), the through hole (121a′) of the second washer (12a′), the fitting hole (151) of the secondary washer (15) and the elastic ring (13), and fastened with the screw nut (14) at the free end thereof. The projected block (122a) of the first washer (12a) adjacent the retaining shoulder (110) is fitted in the corresponding recess (116) of the retaining shoulder (110). The projected block (122a′) of the second washer (12a′) adjacent the secondary washer (15) is fitted in the slot (150) of the secondary washer (15). Whereby when the pivotal axle (1) is turning, the first and second washers (12a, 12a′) turn with the pivotal axle (11).

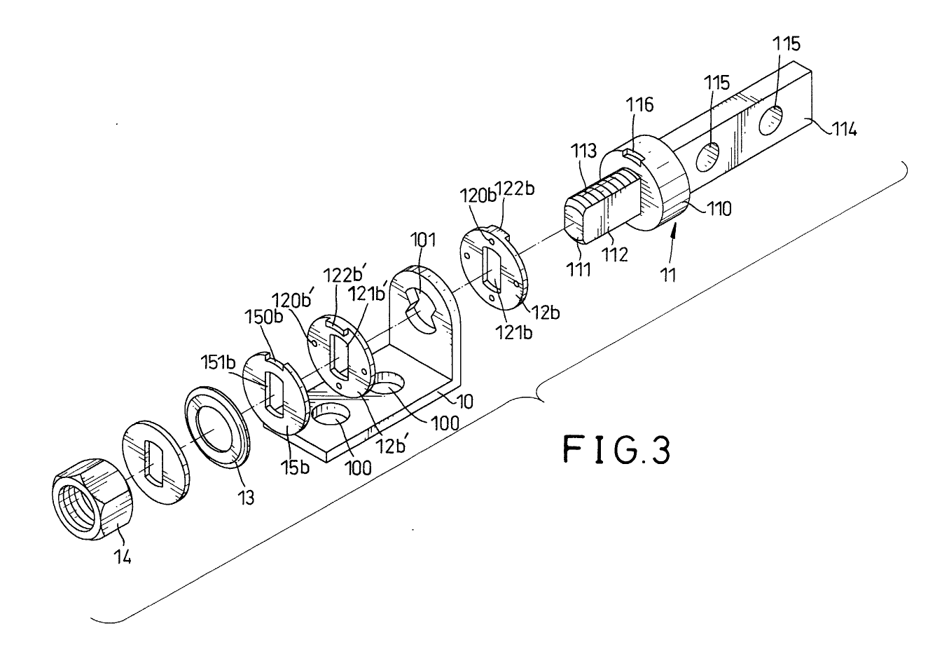

A third embodiment is shown in FIG. 3, wherein in addition to through holes (121b, 121b′) of a first and a second washers (12b, 12b′), the retaining device of the third embodiment is basically same as the retaining device of the second embodiment. The first and second washers (12b, 12b′) in the third embodiment respectively have their through holes (121b, 121b′) shaped corresponding to the cross-sectional shape of the connecting end portion (111) of the pivotal axle (11).

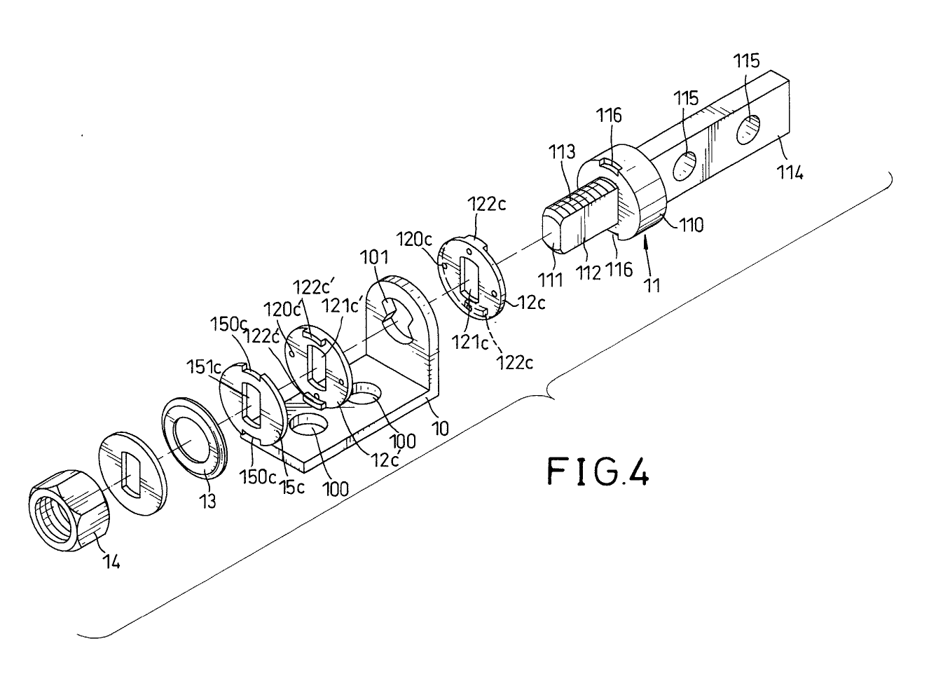

In FIG. 4, a fourth embodiment of the retaining device of the invention has a slight difference to the third embodiment in that a first and a second washers (12c, 12c′) are each integrally formed with two projected blocks (122c, 122c′) at opposite ends of one side thereof. The retaining shoulder (110) of the pivotal axle (11) is defined with two recesses (116) corresponding to the two projected blocks (122c) of the first washer (12c) adjacent the retaining shoulder (110). A secondary washer (15c) is defined with two slots (150c) corresponding to the two projected blocks (122c′) of the second washer (12c′) abutted against the secondary washer (15c).

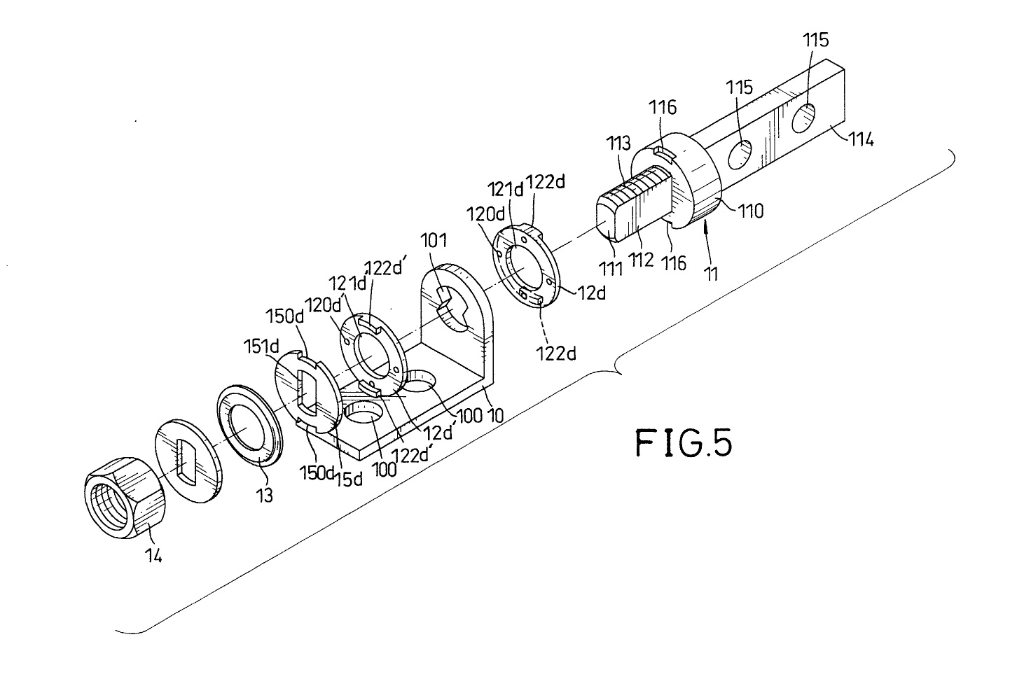

FIG. 5 shows a fifth embodiment of the retaining device of the invention. A difference between the retaining device of the fifth embodiment and the retaining device of the fourth embodiment is that through holes (121d, 12 1d′) of a first and a second washers (12d, 12d′) in the fifth embodiment a.re circular.

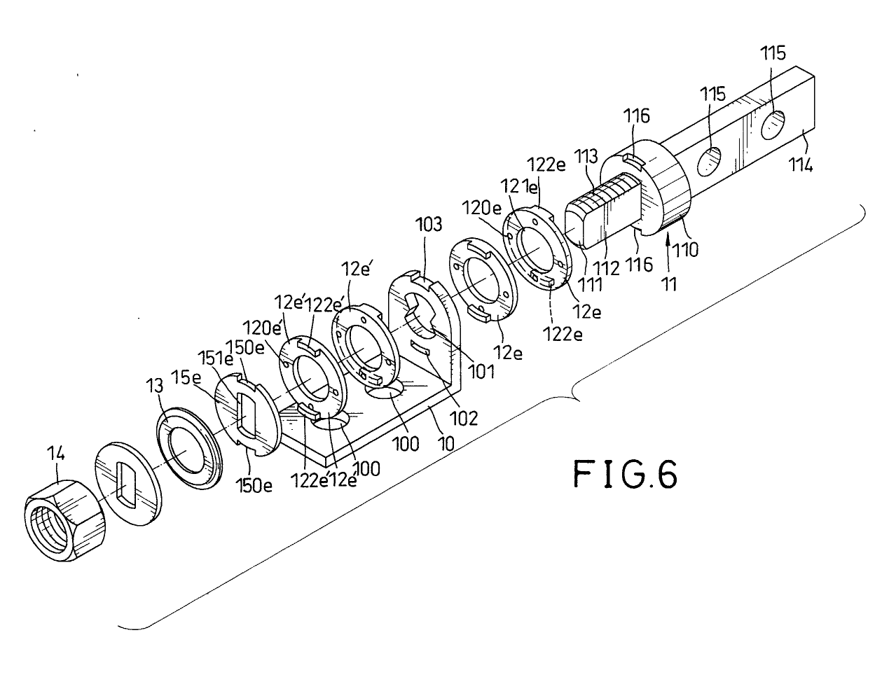

FIG. 6 shows a sixth embodiment of the retaining device of the invention. Two first washers (12e) are provided between the first side of the second end portion of the fixed seat (10) and the retaining shoulder (110) of the pivotal axle (11). Two second washers (12e′) are provided between the second side of the second end portion of the fixed seat (10) and a secondary washer (15e). The connecting end portion (111) of the pivotal axle (11) is extended through the two through holes (121e) of the two first washers (12e), the retaining hole (101e), the two through holes (121e′) of the second washers (12e′), the fitting hole (151e) of the secondary washer (15e) and the elastic ring (13), and fastened with the screw nut (14) at the free end thereof. The retaining shoulder (110) of the pivotal axle (11) is defined with the two recesses (116e) corresponding to the two projected blocks (122e) of the first washer (12e) adjacent the retaining shoulder (110). The secondary washer (15e) is defined with the two slots (150e) corresponding to the two projected blocks (122e′) of the second washer (12e′) abutted against the secondary washer (15e). The second end portion of the fixed seat (10) is defined with a through slot (102) and a groove (103) corresponding to the projected blocks (122e, 122e′) of the first and second washers (12e, 12e′) which are respectively abutted against opposite sides of the second end portion of the fixed seat (10). When the pivotal axle (11) is turning, the first and second washers (12e, 12e′) which are respective abutted against the retaining shoulder (110) and the secondary washer (15e) turn along with the pivotal axle (11), and the first and second washers (12e, 12e′) which are respectively abutted against the opposite sides of the second end portion of the fixed seat (10e) are fixed therewith.

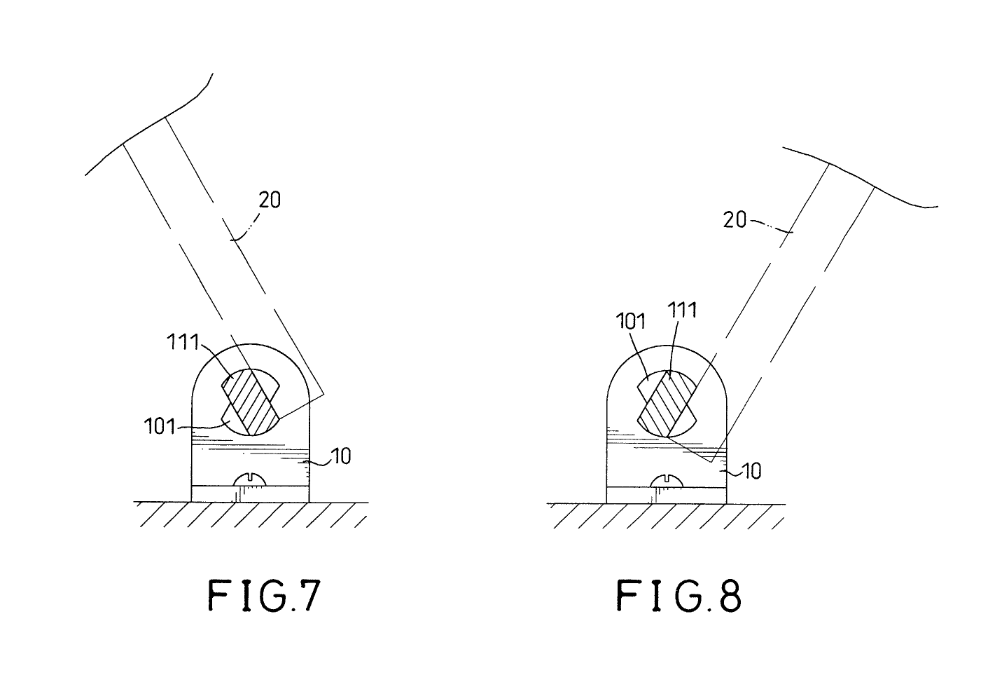

When a screen (20) fixed with the pivotal axle (11) is turned anti-clockwise to a position as shown in FIG. 7, the connecting end portion (111) of the pivotal axle (11) has the flat surfaces (112) thereof retained by bulged edges of the retaining hole (101). When the screen (20) is turned clockwise to a position as shown in FIG. 8, the connecting end portion (111) has the two flat surfaces (112) thereof retained by the bulged edges of the retaining hole (101) also. Therefore the pivotal movement of the pivot of the screen (20) is limited within the retaining hole (101).

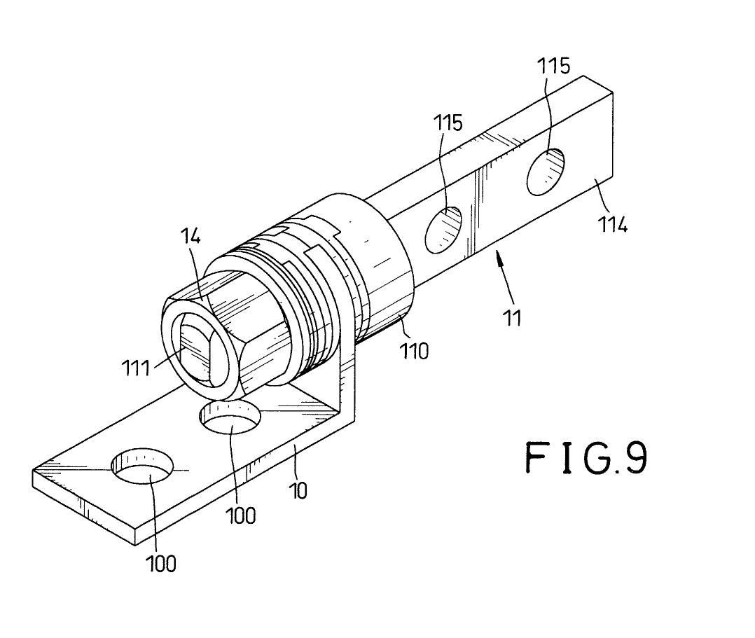

FIG. 9 is an embodiment of assembly of the retaining device in accordance with the invention, wherein the connecting end portion (111) of the pivotal axle (11) has its free end thereof fastened with the screw nut (14).

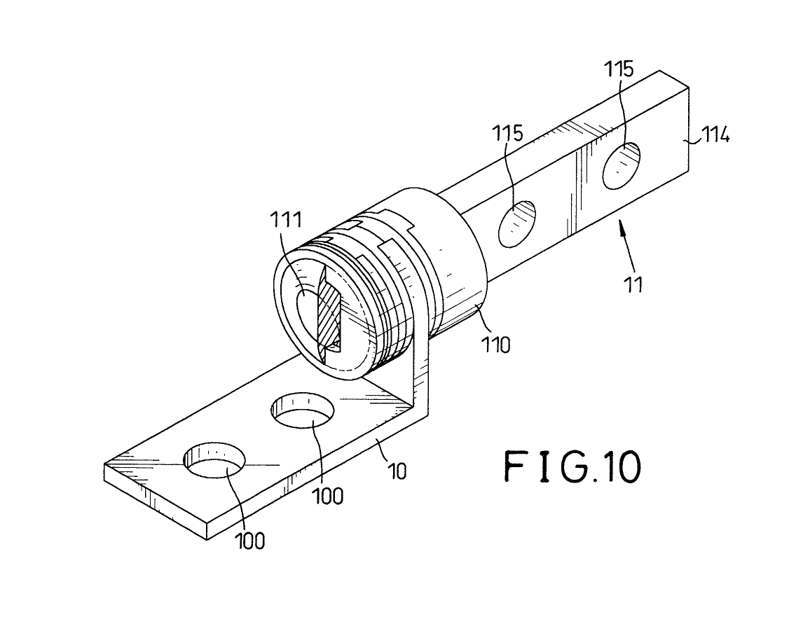

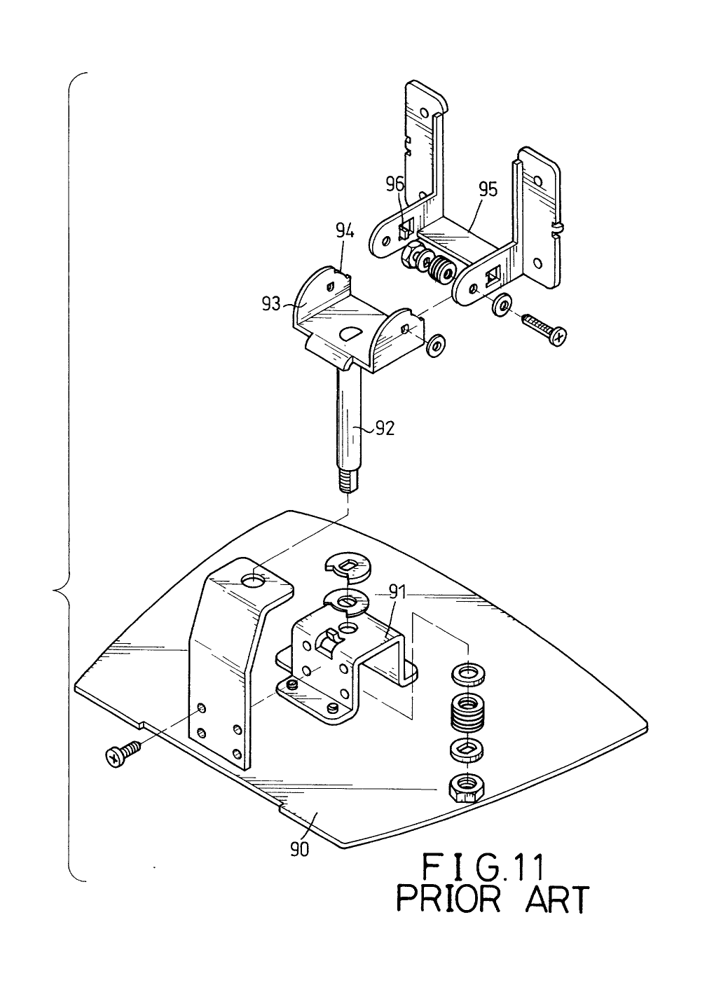

FIG. 10 shows another embodiment of assembly of the retaining device. The connecting end portion (111) has its free end extended through all the previously-described elements and then is punched to be an enlarged end portion to retain the all elements between the fixed seat (10) and the enlarged end portion. In such a way the pivotal axle (11) is pivotally connected with the fixed seat (10) by means of riveting. The free end of the connecting end portion (111) is extended through all the previously-described elements and punched to be an enlarged end, so as to pivotally connect the pivotal axle (11) with the fixed seat (10).

Because the retaining hole (101) and the connecting end portion (111) are hidden in the pivot, and the washers (12) are therein respectively provided with a plurality of oil-holes (120) which can be lubricated, the operation of the pivot is smooth and the use life of the retaining device is prolonged.

A further advantage of the invention is that the structure of the retaining device is simple, so that the manufacturer is able to produce the product at a low cost under a high labor efficiency.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A concealed retaining device of a pivot, the retaining device comprising:
an L-shaped fixed seat (10) having a first end portion and a second end portion, which is substantially perpendicular to the first end portion and is therein defined with a retaining hole (101) shaped substantially as a figure of eight;
a pivotal axle (11) having a retaining shoulder (110) formed at a middle portion thereof, a connecting end portion (111) integrally formed at a first end of the retaining shoulder (110) and having a thread (113) formed therearound and two flat surfaces (112) formed at opposite sides thereof, and a fixing end portion (114) which is integrally formed at a second end of the retaining shoulder (110) and defined with at least two positioning holes (115);
at least one of multiple first washers (12) provided between a first side of the second end portion of the fixed seat (10) and the retaining shoulder (110) of the pivotal axle (11), and at least one of multiple second washers (12′) provided between a second side of the second end portion of the fixed seat (10) and an elastic ring (13), each one of the first and the second washers (12, 12′) defined with a plurality of oil-holes (120, 120′) therearound and defined with a through hole (121) in a center thereof;
whereby the connecting end portion (111) is extended through the through holes (121) of the first washers (12), the retaining hole (101) of the fixed seat (10), the through holes (121 ′) of the second washers (12′) and the elastic ring (13), and fastened at a free end thereof.

2. The concealed retaining device of the pivot as claimed in claim 1, wherein the through holes (121, 121′) of the first and the second washers (12, 12′) are circular.

3. The concealed retaining device of the pivot as claimed in claim 1, wherein the through holes (121) of the first and the second washers (12, 12′) are shaped according to the cross-sectional shape of the connecting end portion (111) of the pivotal axle (11).

4. The concealed retaining device of the pivot as claimed in claim 1, wherein the connecting end portion (111) is extended through the through holes (121) of the first washers (12), the retaining hole (101) of the fixed seat (10), the through holes (121′) of the second washers (12′), and the elastic ring (13), and fastened with a screw nut (14) at the free end thereof.

5. The concealed retaining device of the pivot as claimed in claim 1, wherein the connecting end portion (111) is extended through through hole (121) of the first washers (12), the retaining hole (101) of the fixed seat (10), the through hole (121′) of the second washers (12′) and the elastic ring (13), and fastened by means of riveting.

6. The concealed retaining device of the pivot as claimed in claim 1, wherein the first and the second washers (12, 12′) are respectively and integrally formed with at least one projected block (122, 122′) on a side surface thereof, the retaining shoulder (110) of the pivotal axle (11) is defined with at least one recess (116) corresponding to the at least one projected block (122, 122′) of the first and the second washer (12, 12′) abutted against the retaining shoulder (110), and a secondary washer (15) is provided between the elastic ring (13) and an adjacent one of the second washer (12′) and is defined with a fitting hole (151) corresponding to the cross-sectional shape of the connecting end portion (111) of the pivotal axle (11) and at least one slot (150) corresponding to the at least one projected block (122′) of the second washer (12′) abutted against of the secondary washer (15).

7. The concealed retaining device of the pivot as claimed in claim 6, wherein at least two of the first washers (12) are provided between the first side of the second end portion of the fixed seat (10) and the retaining shoulder (110) of the pivotal axle (11), at least two of the second washers (12′) are provided between the second side of the second end portion of the fixed seat (10) and the elastic ring (13), each one of the first and the second washers (12, 12′) is formed with at least one project block (122, 122′), and the second end portion of the fixed seat (10) is defined with a through slot (102) and a groove (103) respectively corresponding to the projected blocks (122, 122′) of the first and the second washers (12, 12′) which are respectively abutted against the opposite sides of the second end portion of the fixed seat (10).
